(19) United States
(12) Patent Application Publication
(10) Pub. No.: US 2024/0371210 A1
(43) Pub. Date: Nov. 7, 2024

(54) TOLL SYSTEM AND METHOD FOR IMPLEMENTING A PAYMENT PROCESS FOR TRAVELING ON A CHARGEABLE ROUTE SEGMENT WITH A VEHICLE

(71) Applicant: MERCEDES-BENZ GROUP AG, Stuttgart (DE)

(72) Inventors: Jörg ECHARD, Sindelfingen (DE); Martin KEPPLER, Oberreichenbach (DE)

(21) Appl. No.: 18/289,386

(22) PCT Filed: Apr. 27, 2022
(86) PCT No.: PCT/EP2022/061168

§ 371 Date: Nov. 3, 2023

(30) Foreign Application Priority Data
May 4, 2021 (DE) 10 2021 002 374.9

(51) Int. Cl. G07B 15/06

(52) U.S. Cl. CPC G07B 15/063

(57) ABSTRACT

A toll system implements a payment process for traveling on a chargeable route segment with a vehicle. A mobile unit is assigned to the vehicle and a stationary unit is assigned to an operator of the chargeable route segment. A rate of a toll depends on at least two cost parameters. The mobile unit determines the at least two cost parameters and directly or indirectly communicates with the stationary unit in order to implement the payment process. The mobile unit also performs an optimization step in order to find an optimal, cost-effective parameter configuration.

### BACKGROUND AND SUMMARY OF THE INVENTION

Exemplary embodiments of the invention relate to a toll system for implementing a payment process for traveling on a chargeable route segment with a vehicle, to a method for implementing a payment process with such a toll system, and to a vehicle.

The building and operation of roads is associated with comparatively high costs. As such, road network operators charge fees for traveling on a chargeable route segment, such as a portion of a freeway, a tunnel, a specific road network section of a city, a low emission zone, or the like, before a vehicle may drive on the corresponding route segment. Nuisances due to noise and/or emissions can also be compensated for by means of such a toll.

Many methods exist for the payment of the toll. As such, in some countries, there is a requirement to arrange a vignette visibly behind the windshield of a vehicle traveling on a chargeable route segment. Such a vignette is valid for a certain period of time—for example, a week, a month, or a year. A corresponding chargeable route segment can also have an access control, e.g., in the form of a barrier, where a ticket is provided. The ticket must then be paid for when the driver exits the chargeable route segment. The amount in this case is based upon a distance traveled by the vehicle on the chargeable route segment. Automated systems are also known for increasing user convenience. As such, if a person driving a vehicle wishes to drive a certain route segment subject to tolls, the person can store billing information, as well as a plate number of the vehicle, in advance with the relevant operator of the route segment subject to tolls. Then, when the vehicle approaches the route segment subject to tolls, the license plate number of the vehicle is detected by means of a camera system, permission to access the route segment subject to tolls is granted to the driver, and a debit is automatically taken according to the costs in effect.

In addition, toll systems are known that create an incentive to form rideshares. This makes it possible to reduce traffic in cities with heavily traveled roads—in particular, during rush hour. Using so-called carpool lanes, vehicle occupants participating in a rideshare have the possibility of arriving at the destination more quickly. For instance, a special carpool lane exists in which only vehicles that have more than one person inside are allowed to travel. In order to prevent misuse, it is necessary to detect the number of vehicle occupants of a vehicle using a carpool lane.

A corresponding method is known from US 2019/0279437 A1. In this case, a number of vehicle occupants riding in the vehicle is recognized by means of a mobile terminal, such as a smartphone, by voice recognition. Additionally, or alternatively, it is also possible to make photo or video recordings of the persons in the vehicle. A discount for traveling on a route segment subject to tolls is granted as a function of the number of occupants in a vehicle. The more people traveling in the vehicle, the less expensive the trip. The method also includes the possibility of a convenient and simple division of costs between the vehicle occupants. The toll collection is started as soon as the vehicle travels in a defined lane, which is automatically determined by means of position monitoring, and/or as soon as the vehicle exceeds a certain critical speed.

Exemplary embodiments of the present invention are directed to a toll system and a method for implementing a payment process for traveling on a chargeable route segment with a vehicle, by means of which a willingness of a driver to travel on a chargeable route segment can be increased.

In a toll system for implementing a payment process for traveling on a chargeable route segment with a vehicle, of the type mentioned at the outset, the mobile unit is further configured to carry out an optimization step in order to find an optimal, cost-effective parameter configuration.

By finding the optimal, cost-effective parameter configuration, the toll system according to the invention enables a driver of the vehicle to travel on the chargeable route segment, e.g., a freeway subject to tolls, a tunnel, a low-emission zone, a city area with a city toll, a parking lot, or the like, in a particularly cost-effective manner. By taking into account and optimizing multiple cost parameters, dynamic pricing is possible, which makes it possible to offer discounts for traveling on the chargeable route segment, wherein, because various cost parameters are taken into account, a particularly broad adaptation to different scenarios is possible. As such, a willingness of a driver to travel on the chargeable route segment is increased, since the driver must pay, by means of the toll system according to the invention, a comparatively lower toll rate for traveling on the chargeable route segment. In the case of fully-automatic tolling, the convenience for the driver can also be further improved. This also contributes to improving the acceptance of traveling on the chargeable route segment.

In the optimization step, taking into account the at least two cost parameters, a parameter combination is selected such that the toll rate to be paid is as low as possible. Tested and proven optimization methods are used for this purpose.

Both the mobile unit and the stationary unit have corresponding communications interfaces for direct communication with one another. In this case, the mobile unit also allows an unambiguous identification of the vehicle in order to be able to unambiguously assign fees incurred by the vehicle for traveling on the chargeable route segment. For example, communication by radio-such as mobile radio, Wi-Fi, Bluetooth or the like—is possible. Data transmission via visible or invisible light, such as infrared, is also conceivable. For identification, the vehicle can have a corresponding transponder, or an identification feature of the vehicle, e.g., a license plate number, can be detected by the stationary unit by evaluating camera images. For example, for billing purposes, the driver can store relevant data online with the operator of the chargeable route segment. These include, for example, an address, account data, a profile assigned to the driver, or the like. The driver can provide notification of intention to travel on the chargeable route segment, e.g., by registering the license plate number of the vehicle and paying the toll in advance, or the driver can do this when arriving at an access point to the chargeable route segment. It is also conceivable for the toll to be paid immediately upon exiting the chargeable route segment, and/or on a payment date—for example, at the end of the month.

An advantageous embodiment of the toll system provides that the mobile unit be permanently integrated into the vehicle, or be formed by a mobile terminal. As such, the mobile unit can be formed, for example, by a computing unit of the vehicle and subsystems connected thereto, such as a display for outputting information and an input means for inputting relevant data. The computing unit can be formed by a separate computing unit or also by a central, on-board computer, a telematic unit, or a control unit of a vehicle subsystem. It is also conceivable that a mobile terminal such as a smartphone, tablet computer, laptop or the like be used as the mobile unit. On a corresponding computing unit, a software program or application can be executed, by means of which the driver logs in, with a profile associated with the driver, with the operator of the chargeable route segment for traveling on the chargeable route segment. With the aid of the profile, it is possible to store extensive data, such as a time typically used for traveling on the chargeable route segment and a frequency with which the chargeable route segment is traveled, and associate it with a specific person. Such information can be taken into account in the pricing of the tolls. In this case, it is also conceivable for the mobile terminal to be in data-transmitting connection with a computing unit that is permanently integrated into the vehicle. For example, the computing unit of the vehicle can exchange data via a wireless communications interface of the mobile terminal—for example, by mobile radio, and in particular via the Internet. Similarly, the mobile terminal can read relevant information from the computing unit of the vehicle, such as a planned route, a license plate number, or a chassis number.

In accordance with a further advantageous embodiment of the toll system, in addition to the mobile unit and to the stationary unit, at least one service unit is provided, which is configured to implement the indirect communication between the mobile unit and the stationary unit to carry out the payment process. The service unit is an infrastructure of a service provider such as an internet server.

As such, the service provider mediates between the mobile unit and the stationary unit and, for example, forwards personal data of the driver to the operator of the chargeable route segment, whereupon the service provider returns a permission to drive on the chargeable route segment to the mobile unit. This permission can, for example, simply be information that there is permission to travel on the chargeable route segment, or can be a numerical code stored in the mobile unit and read by the stationary unit from the mobile unit when entering the chargeable route segment.

The service unit and/or service provider can also be included in the pricing of the rates for the toll. By way of example, due to its range and special pricing, the service provider can ensure that the driver travels more frequently on the chargeable route segment, and/or more persons or vehicles use the chargeable route segment. In other words, the service provider can carry out a customer acquisition for the operator of the chargeable route segment. A customer benefits from the fact that toll fees for an individual person can be reduced, and that the payment process for the payment of the toll fees is conveniently managed by the service provider, which reduces administrative effort for the customer in the use of chargeable route segments operated by various operators.

A further advantageous embodiment of the toll system provides that the mobile unit and the stationary unit be configured to take into account more than three cost parameters for the rate of the toll. As a result, an even more flexible adaptation of the pricing of the toll to a wide variety of scenarios is possible. This also allows particularly complex relationships to be recognized in the optimization step and to be used to determine the most cost-effective parameter configuration. Preferably, all relevant cost parameters are taken into account in the optimization step.

In a method for implementing a payment process with a toll system described above, at least one cost parameter is formed according to the invention from:
a vehicle-intrinsic parameter;
a driving-strategy-intrinsic parameter;
a route-segment-intrinsic parameter; and/or
a traffic-intrinsic parameter.

In this case, the type of engine in the vehicle, an exhaust gas regulation, vehicle dimensions, an axle count, a vehicle weight, a permissible total weight of the vehicle, an engine displacement of an internal combustion engine of the vehicle, or a fuel type of the vehicle is preferably used as the vehicle-intrinsic parameter.

In particular, a maximum speed traveled on the chargeable route segment, an average speed, a time of day at which the chargeable route segment is traveled, a trip duration, or a travel route is used as a driving-strategy-intrinsic parameter.

The presence of a structural obstacle on the chargeable route segment, a usage frequency of the chargeable route segment, the existence of a subscription, or the use of a voucher is preferably used as the route-segment-intrinsic parameter.

In particular, an obstruction due to a traffic jam or congestion or the existence of a rush hour is used as a traffic-intrinsic parameter.

By taking into account and optimizing several of the parameters listed above, toll rates can be designed in such a way that traffic volume is evened out on the chargeable route segment, i.e., that a consistent vehicle count makes use of the chargeable route segment at different times, and the convenience of a person who uses the chargeable route segment is improved by the offering of cost-effective rates. If there is a high traffic volume on the chargeable route segment, e.g., during a rush hour, or if delays, e.g., due to a construction site, exist, it is possible to demand particularly high rates, such that fewer persons use the chargeable route segment, which evens out the traffic volume. In this case, however, it is also possible to offer particularly favorable rates in order to compensate a person who uses the chargeable route segment for the increased duration of travel.

The toll rate can also be different for different vehicle types. If a vehicle has an internal combustion engine, for example, a higher toll rate can be required for this vehicle than for a plug-in hybrid electric vehicle, or a purely battery-powered vehicle. In this way, environmental aspects can be taken into account in the pricing. Similarly, a toll rate for a particularly large vehicle or heavy vehicle and an inexpensive toll rate for a small and lightweight vehicle can be selected.

A toll rate can also be linked to a driving-strategy-intrinsic parameter. For example, a higher toll rate can be required if a driver wishes to pass the chargeable route segment at a particularly high vehicle speed. As a result, a higher safety risk due to an accident risk associated with the higher speed can be addressed. Due to a lower accident potential associated with a lower vehicle speed, it is possible to pay lower toll fees to travel on the chargeable route segment at a lower vehicle speed. This results in more people requesting slower travel on the chargeable route segment. This potentially also results in less braking maneuvers, which also reduces a risk of congestion. Similarly, the time of day can also be taken into account for pricing. For example, more favorable rates can be offered at night than during the day.

By providing subscriptions, vouchers, or quantity discounts, even more favorable rates can be offered for travel on the chargeable route segment. If a certain person uses the chargeable route segment, for example, eight times, and a flat rate is offered for traveling on the chargeable route segment ten times, or more frequently, the total costs of which are lower than traveling eight single times individually, a corresponding message can be displayed to a driver, whereupon the driver selects the subscription and/or travels on the chargeable route segment even more frequently.

By integrating the service unit or the service provider into the implementation of the payment process, extensive data on a driver can be taken into account during the pricing. A typical travel behavior of a specific driver can thus be detected and evaluated in order to suggest, for example, a particularly cost-effective time window and a cost-effective driving strategy for traveling on a chargeable route segment.

Preferably, at least two—but, in particular, more than three, and very preferably all-relevant cost parameters are taken into account for determining the rate of the toll. Thus, for example, a particularly favorable toll rate can be offered if a driver travels on the chargeable route segment with a battery-powered electric vehicle and a maximum speed of 100 km/h. The rate of the toll can be more expensive if a combustion vehicle is used for this purpose. In addition, further discounts can be granted if the maximum speed is limited to below 100 km/h. In this case, a discount for the combustion vehicle can then be greater, since less CO2 is emitted as a result.

According to a further advantageous embodiment of the method, the mobile unit reads the cost parameters relevant to the rate from a memory, and/or queries the parameters from the stationary unit or the service unit. The memory can here be comprised by the mobile unit, or also by the vehicle. If the cost parameters currently relevant to the rate are read out from a memory, the mobile unit can access the relevant cost parameters particularly quickly, and can accordingly also particularly quickly suggest an optimal parameter configuration to the driver, i.e., the most cost-effective parameter configuration for traveling on the chargeable route segment. With the aid of a communications interface, the mobile unit can also query the corresponding cost parameters for an update, to thereby prevent obsolete rate information from being used. The stationary unit and/or the service unit can also input new cost parameters.

A further advantageous embodiment of the method further provides that a parameter value of at least one cost parameter be read out from a memory, determined by a sensor, or determined by a manual input. For example, parameter values of cost parameters that do not change can be stored in the memory. This includes, for example, a maximum load of the vehicle, a permissible total weight, an engine displacement, an engine type, vehicle dimensions, or the like. With the aid of a sensor, variable or dynamic parameter values can be read out. This includes, for example, a current vehicle speed, an average speed, a route traveled, a distance traveled, a duration, a vehicle occupant number, a current vehicle load, or the like. If a determination of such a relevant parameter value is not possible by means of sensors, a manual input can also take place—for example, to an input means comprised by the vehicle or an input means of the mobile unit. For example, the driver can input into a smartphone the load transported by the vehicle, or the smartphone can transmit corresponding information to the stationary unit by reading out position information, such as GPS and a current time. This can include, for example, the fact that the vehicle has traveled a certain portion of the chargeable route segment at a certain speed at night.

According to a further advantageous embodiment of the method, the optimization step is carried out after the chargeable route segment has been traveled. This allows the cost parameters present during the travel of the chargeable route segment, and their rate values, to be evaluated after the chargeable route segment is exited, and allows determination of a corresponding, optimized toll rate. This makes it possible, for example, to take into account a distance covered on the chargeable route segment if this has not been previously transmitted to the operator of the chargeable route segment, or to take into account spontaneously changing boundary conditions, such as a sudden increase in traffic volume, or a change from an electric drive mode to an internal-combustion-based drive mode.

According to the invention, a vehicle comprises a mobile unit of a toll system described above. The vehicle is any vehicle, such as a passenger car, semi-truck, transport truck, bus, or the like. The vehicle can have an internal combustion engine and/or an electric motor as a drive machine. A corresponding vehicle can be controllable manually, at least partially automatically, or even fully automatically. Thus, for example, for trucks-particularly in the transport of hazardous goods-a particularly high toll rate can be selected, which can be reduced if the truck transporting the hazardous goods, for example, is operated autonomously, selects a comparatively slow travel speed, and maintains a particularly high safety distance from further road users, and/or takes the chargeable route segment at a time in which there is typically a low traffic volume on the chargeable route segment.

Further advantageous embodiments of the toll system and the method according to the invention follow from the exemplary embodiment, which is described in more detail below with reference to the figures.

### BRIEF DESCRIPTION OF THE DRAWING FIGURES

In the figures:

FIG. 1 is a schematic representation of a vehicle entering a chargeable route segment; and

FIG. 2 is a schematic representation of a payment process according to one embodiment of a method according to the invention.

### DETAILED DESCRIPTION

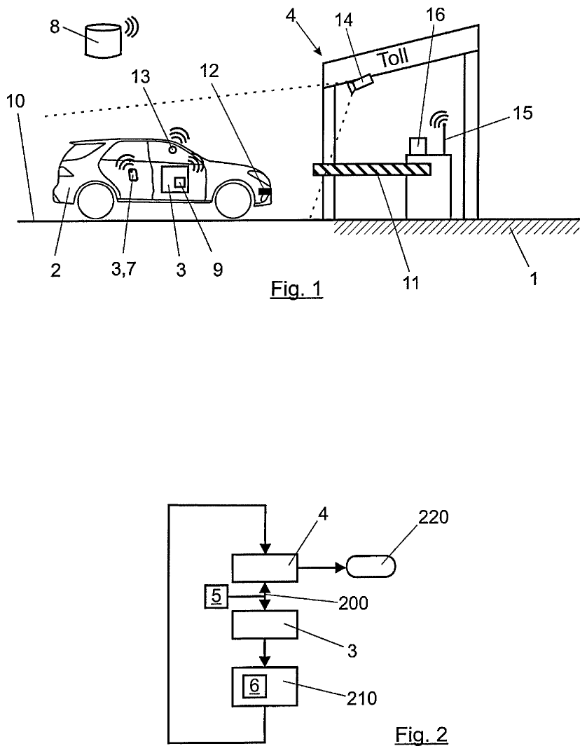

FIG. 1 shows a vehicle 2 driving on a road surface 10 on a chargeable route segment 1. Access to the chargeable route segment 1 is granted by an operator of the chargeable route segment 1 by means of a stationary unit 4. This is, for example, a toll station with a barrier 11. Such a toll station can also be provided at an exit of the chargeable route segment 1.

The vehicle 2 comprises a mobile unit 3—here in the form of a mobile unit 3 permanently integrated into the vehicle 2—and a mobile terminal 7—here in the form of a smartphone. The mobile unit 3 is in indirect or direct data exchange with the stationary unit 4 via a communications link. The mobile unit 3 receives from the stationary unit 4 at least two cost parameters 5 illustrated in FIG. 2. A toll rate incurred for traveling on the chargeable route segment 1 depends upon the cost parameters 5 in this case. In an optimization step 210, likewise shown in FIG. 2, the mobile unit 3 determines an optimal, most favorable parameter configuration 6 (see also FIG. 2) from the cost parameters 5 transmitted from the stationary unit 4 to the mobile unit 3.

In addition to the mobile unit 3 and the stationary unit 4, a toll system according to the invention also comprises a service unit 8. This is, for example, a backend of a service provider. In this case, communication between the mobile unit 3 and the stationary unit 4 can take place via the service unit 8. This allows a driver of the vehicle 2 to use paid route segments 1 operated by different operators in a convenient manner—for example, by the provision of a central profile for the service provider on the service unit 8. Thus, it is not necessary for the driver to have to log in again with each operator of a chargeable route segment 1.

In order to identify the vehicle 2 and/or the driver at the operator of the chargeable route segment 1, the vehicle 2 comprises an identification feature such as a license plate number 12 or a transponder 13, for example. For detecting or reading out the identification feature, the stationary unit 4 comprises, for example, a camera 14 or a radio module 15. Furthermore, the stationary unit 4 can, for example, have an authentication module 16 on the barrier 11. This is, for example, an input means for inputting a unique identifier such as a username and a password, a payment means for inserting cash or inserting a credit card, or an NFC interface via which the mobile terminal 7 can transmit a corresponding identifier of the vehicle 2 or the driver to the stationary unit 4. After authentication of the vehicle 2 and/or the driver has taken place, the barrier 11 opens, and the vehicle 2 can enter the chargeable route segment 1. Similarly, the authentication can also take place when exiting the chargeable route segment 1.

Furthermore, the mobile unit 3 comprises a memory 9. The memory 9 can also be comprised by the mobile terminal 7 or the vehicle 2. The memory 9 stores parameter values of cost parameters 5 which are unchangeable—for example, the dimensions of the vehicle 2.

FIG. 2 shows a basic illustration of a payment process which allows the vehicle 2 to enter the chargeable route segment 1 and/or which occurs after the vehicle 2 has entered the chargeable route segment 1 or has exited it.

In method step 200, the mobile unit 3 establishes contact with the stationary unit 4. The stationary unit 4 and the mobile unit 3 then exchange cost parameters 5. In an optimization step 210, the mobile unit 3 determines an optimal, i.e., most cost-effective, parameter configuration 6, by means of which a particularly low rate for the toll to be paid can be selected. The optimal, cost-effective parameter configuration 6 is then transmitted to the stationary unit 4. In a method step 220, the travel on the chargeable route segment 1 is then billed according to the optimal, most cost-effective parameter configuration 6.

With the aid of the toll system according to the invention and the method according to the invention for implementing a payment process with such a toll system, particularly favorable rates can be offered for the driver of the vehicle 2, and, in addition, traffic volume on the chargeable route segment 1 is controlled in a targeted manner. As a result, a willingness of the driver to travel on the chargeable route segment 1 is increased. In this way, the design of the payment process is particularly convenient for the driver, and in addition, with a favorable rate, an incentive to travel on the chargeable route segment 1 is created, or traffic volume is reduced at peak times on the chargeable route segment 1, which minimizes a risk of congestion.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

1-10. (canceled)

11. A toll system configured to implement a payment process for traveling on a chargeable route segment, the toll system comprising:
a vehicle comprising a mobile unit assigned to the vehicle; and
a stationary unit assigned to an operator of the chargeable route segment,
wherein a rate of a toll depends upon at least two cost parameters,
wherein the mobile unit is configured to
determine the at least two cost parameters and communicate with the stationary unit directly or indirectly in order to implement the payment process, and
perform an optimization to determine an optimal, cost-effective parameter configuration.

12. The toll system of claim 11, wherein the mobile unit is permanently integrated into the vehicle or the mobile unit is formed by a mobile terminal.

13. The toll system of claim 11, further comprising:
at least one service unit configured to implement the indirect communication between the mobile unit and the stationary unit to implement the payment process.

14. The toll system of claim 11, wherein the at least two cost parameters comprise more than three cost parameters, and wherein the mobile unit and the stationary unit are configured to take into account the more than three cost parameters for the rate of the toll.

15. A method for implementing a payment process for traveling on a chargeable route segment, the method comprising:
determining, by a vehicle, at least two cost parameters, wherein a rate of a toll depends on the at least two cost parameters;
performing, by the vehicle, an optimization to determine an optimal, cost-effective parameter configuration; and
communicating, by the vehicle with a stationary unit assigned to an operator of the chargeable route segment, directly or indirectly in order to implement the payment process,
wherein at least one of the at least two cost parameters is formed from
a vehicle-intrinsic parameter,
a driving-strategy-intrinsic parameter,
a route-segment-intrinsic parameter, or
a traffic-intrinsic parameter.

16. The method of claim 15, wherein
the vehicle-intrinsic parameter is a type of engine or motor in the vehicle, an exhaust gas regulation, dimensions of the vehicle, an axle count, a weight of the vehicle, a permissible total weight, an engine displacement, or a fuel type of the vehicle,
the driving-strategy-intrinsic parameter is a maximum speed at which the chargeable route segment is traveled, an average speed, a time of day at which the chargeable route segment is traveled, a trip duration, or a travel route,
the route-segment-intrinsic parameter is a presence of a structural obstacle on the chargeable route segment, a usage frequency of the chargeable route segment, existence of a subscription, or use of a voucher, or
the traffic-intrinsic parameter is an obstruction due to a traffic jam or congestion, or existence of a rush hour.

17. The method of claim 15, further comprising:
reading-out, by the mobile unit, out up-to-date cost parameters relevant to the rate from a memory; or
querying, by the mobile unit from the stationary unit or the service unit, the out up-to-date cost parameters relevant to the rate.

18. The method of claim 15, wherein the at least one of the at least two cost parameters is read out from a memory, determined by a sensor, or determined by a manual input.

19. The method of claim 15, wherein the optimization is performed after the chargeable route segment has been traveled.

20. A vehicle configured to implement a payment process for traveling on a chargeable route segment, the vehicle comprising:
a mobile unit permanently integrated into the vehicle or formed by a mobile terminal, wherein the mobile unit is configured to
determine at least two cost parameters, wherein a rate of a toll depends on the at least two cost parameters;
perform an optimization to determine an optimal, cost-effective parameter configuration; and
communicate, with a stationary unit assigned to an operator of the chargeable route segment, directly or indirectly in order to implement the payment process.
